(19) United States
(12) Patent Application Publication
(10) Pub. No.: US 2008/0035570 A1
(43) Pub. Date: Feb. 14, 2008

(54) Catch basin insert

(76) Inventor: Octavio Lugo, Corona, CA (US)

Correspondence Address: KOPPEL, PATRICK & HEYBL, 555 ST. CHARLES DRIVE, SUITE 107, THOUSAND OAKS, CA, 91360, US

(21) Appl. No.: 11/321,353

(22) Filed: Dec. 28, 2005

Related U.S. Application Data
(60) Provisional application No. 60/639,341, filed on Dec. 28, 2004.

(51) Int. Cl. B01D 61/00

(52) U.S. Cl. 210/650

(57) ABSTRACT

A catch basin insert arranged to help filter out trash and debris as water passes through the catch basin. One embodiment of a catch basin insert according to the present invention comprises a mounting frame and a skin mounted to the mounting frame, the skin having openings to allow water and other liquids to pass through. The insert further comprises a means for mounting the frame to a wall over an opening, and includes a top opening not covered by the skin. The top opening has one or more openings larger than said skin openings to allow a greater volume of water to pass.

### RELATED APPLICATION DATA

This application claims the benefit U.S. Provisional Application Ser. No. 60/639,341 filed Dec. 28, 2004.

### BACKGROUND OF THE INVENTION

1. Field of the Invention

This invention relates to catch basins and in particular to catch basin inserts that capture trash and debris before being discharged into a source water body.

2. Description of Related Art

Catch basins are commonly provided as part drainage systems. For example, many streets have catch basins provided periodically along the street, underground and at the edge of the street. An opening is provided to allow water to run into the catch basin from the street. The catch basins typically have an opening and conduit that provides a path for the water to run from the catch basin to a storm drainage system. The water then typically runs to a receiving water body.

Trash and debris can also enter catch basins and most conventional catch basis have no means for filtering out the debris before it runs into the storm drainage system and on to the receiving water body. This can result in street debris and trash making its way to and polluting the receiving water body.

### SUMMARY OF THE INVENTION

Briefly, and in general terms, the invention provides a catch basin insert arranged to help filter out trash and debris as water passes through the catch basin. One embodiment of a catch basin insert according to the present invention comprises a mounting frame and a skin mounted to the mounting frame, the skin having openings to allow water and other liquids to pass through. The insert further comprises a means for mounting the frame to a wall over an opening, and includes a top opening not covered by the skin. The top opening has one or more openings larger than said skin openings to allow a greater volume of water to pass.

Catch basin inserts according to the present invention are particularly adapted to being mounted over openings in conventional catch basins. As water flows into the catch basin it passes through the skin to the catch basin opening to flow out of the catch basin. The skin captures most trash and debris before it leaves the catch basin. The catch basin's top opening allows water to still flow out of the catch basin opening during storm overflow condition or if the skin is clogged by debris.

These and other aspects and advantages of the invention will become apparent from the following detailed description and the accompanying drawings which illustrate by way of example the features of the invention.

### BRIEF DESCRIPTION OF THE DRAWINGS

FIG. 1 is a perspective view of one embodiment of a catch basin insert according to the present invention;

FIG. 2 is a perspective view of one embodiment of a catch basin insert according to the present invention installed in a catch basin;

FIG. 3 is a front elevation view of one embodiment of a catch basin insert according to the present invention;

FIG. 4 is a side elevation view of the catch basin insert shown in FIG. 3;

FIG. 5 is a plan view of the catch basin insert shown in FIG. 3;

FIG. 6 is a front elevation view of another embodiment of a catch basin insert according to the present invention;

FIG. 7 is a side elevation view of the catch basin insert shown in FIG. 6;

FIG. 8 is a plan view of the catch basin insert shown in FIG. 6;

FIG. 9 is a front elevation view of another embodiment of a catch basin insert according to the present invention;

FIG. 10 is a side elevation view of the catch basin insert shown in FIG. 9;

FIG. 11 is a plan view of the catch basin insert shown in FIG. 9;

FIG. 12 is a front elevation view of a mounting frame for a removable catch basin insert according to the present invention;

FIG. 13 is a side elevation view of the mounting frame shown in FIG. 12;

FIG. 14 is a plan view of the mounting frame shown in FIG. 12;

FIG. 15 is a front elevation view of still another embodiment of a catch basin insert according to the present invention;

FIG. 16 is a side elevation view of the catch basin insert shown in FIG. 15; and

FIG. 17 is a plan view of the catch basin insert shown in FIG. 15.

### DETAILED DESCRIPTION OF THE PREFERRED EMBODIMENTS

Catch basin inserts according to the present invention are designed to capture trash and debris in convention street catch basins to help prevent non-point source pollutants from discharging into storm drains. The insert maximizes trash capture within the catch basin before the trash can be discharged into receiving water bodies. The inserts according to the present invention retain trash and litter inside the catch basin while allowing storm water and urban runoff to continue into the storm drain system. Many prior inserts utilize a very small portion of the catch basin's available storage capacity, while the inserts according to the present invention maximize the trash storage capacity within the catch basin. Different embodiments of the inserts can make use of up to 95% or more of the catch basin's available storage capacity.

The inserts are easy to install and their design allows for installation in different size catch basins. Different embodiments of the inserts can also prevent flooding of the catch basin during storms by providing an overflow, and embodiments can also include a grating design that allows the inserts to retain floating trash and debris within the catch basin, even during large storm overflow.

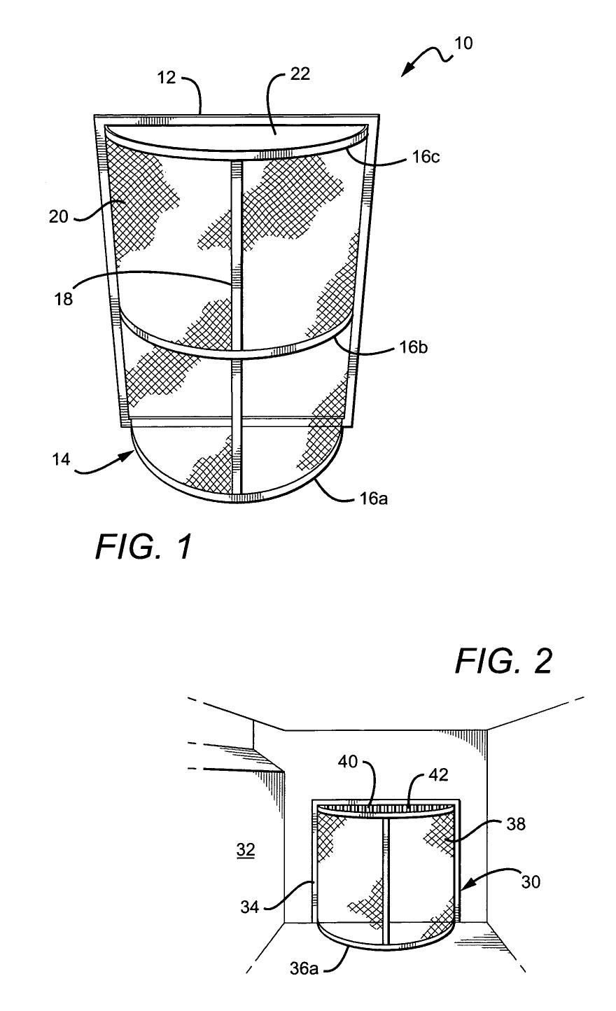

FIG. 1 shows one embodiment of a catch basin insert 10 according to the present invention that is designed to be fitted over a catch basin storm drain opening. The insert 10 generally comprises a mounting frame 12 that is mounted to the wall of the catch basin, with the frame 12 around the catch basin opening. The frame can be made of many different rigid materials, with a suitable material being a metal, and the frame can be manufactured using known methods.

A screen support structure 14 is mounted to the frame 12 and in the embodiment shown, the support structure 14 is a half cylindrical shape. The structure 14 generally comprises first, second and third cross-members 16a-c, spanning between the vertical legs of the frame 12. Each of the cross-members form a half circle between the frame's vertical legs, with the first cross-member 16a, second cross-member, and third cross-member preferably being at the bottom, middle and top of the frame 12, respectively. The support structure 14 can also comprise a central vertical brace 18 spanning between the cross-member 16a-c, preferably attaching to the mid-point of each.

A skin 20 can be attached over the support structure 14 using known methods and devices, such as screws, rivets, or by welding. The skin 20 is arranged to allow water and other liquids to pass through, while preventing objects such as trash and debris from passing. Many different materials can be used for the skin, with a preferred material being a commercially available screen. Depending on the application, different screens with different sized openings can be used. The preferred screen has 5 millimeter openings. The screen can be made of many different materials, with suitable materials being metal or plastic.

The insert top 22 can be open as shown or can have horizontal bars (shown below) spanning between the third cross-member 16c and the horizontal member of the mounting frame 12. The horizontal bars comprise a grating system. When the catch basin experiences large storm overflow, the flow of water into the catch basin may be greater than the amount of water that can pass through the skin 20. This can cause the level of water in the catch basin to rise and as the level of water passes the third cross member 16c, water flows into the top opening 22 and into catch basin opening without passing through the skin 20. This allows the insert to catch litter and debris in most common storm overflows, but does not block flow during large storm overflows. The grating system can still capture large or floating pieces of debris and trash.

The top opening 22 can also be utilized to allow continued flow of water if the openings of the skin become clogged such that water does not pass. As the catch basin fills because of the clogged skin, it will rise above the third cross-member 16c and flow out the top opening 22.

FIG. 2 shows a catch basin insert 30 according to the present invention mounted within a convention catch basin 32. During storms, water flows into the catch basin 32 and out a catch basin opening to a storm drain system. Conventional catch basins had no mechanism for capturing trash or debris that would flow into the catch basin with the water flow. As shown, the catch basin insert 30 is mounted to the wall of the catch basin, over the catch basin opening. The mounting frame 14 is around the catch basin opening, with the bottom of the mounting frame adjacent to the bottom of the catch basin 32. The first cross-member 36a is also adjacent to the bottom of the catch basin 32. Water flowing into the catch basin 32 passes through the skin 38 of the catch basin and out the catch basin opening. Debris and trash can be captured at the skin before passing out the opening. The top opening 40 allows for increased water flow during increased storm overflow and has a grating system to capture large or floating debris during this overflow.

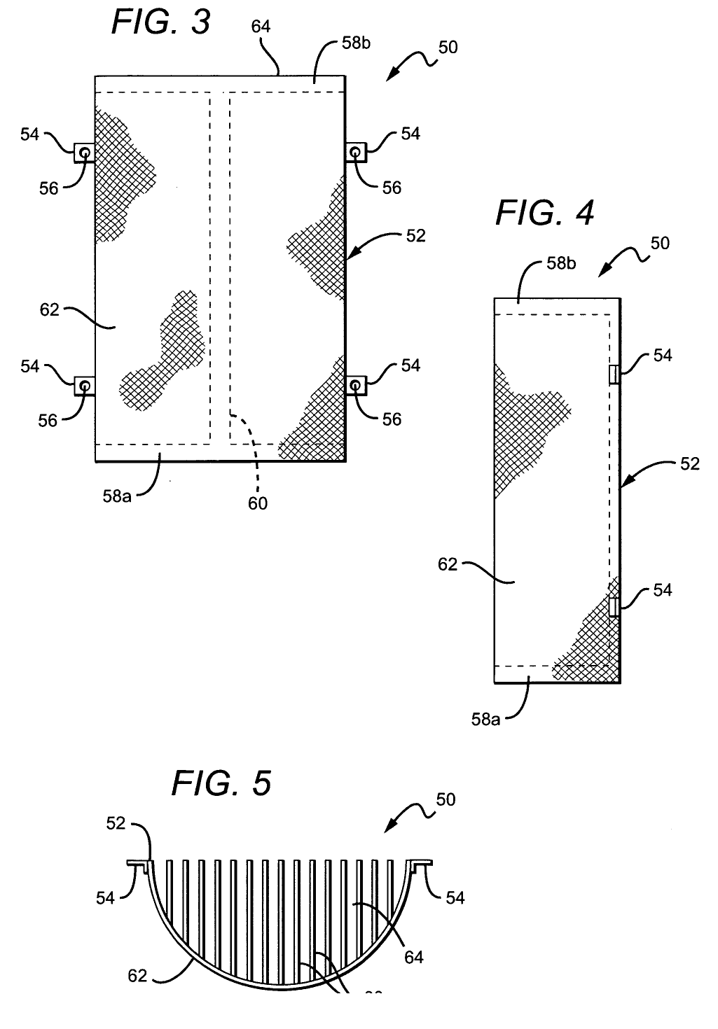

FIGS. 3-5 show another embodiment of a catch basin insert 50 according to the present invention, comprising a mounting frame 52 to be mounted to the inside of a catch basin around the catch basin opening. The frame 52 comprises mounting tabs 54, each extending away from the frame 52 and when the insert 50 is installed, the tabs 54 are against the catch basin wall. Each tab has a tab hole 56 that allows a mounting device, such as a screw, to pass through the hole and into the catch basin wall to anchor the catch basin insert 50 to the wall. It is understood that the catch basin insert 50 can be mounted to the catch basin wall using many different devices and in many different ways beyond those described herein.

The insert 50 comprises first and second half-circle cross-members 58a, 58b, with the first cross-member 58a extending between the bottom of the frame's vertical legs and the second cross-member 58b extending between the top of the frame's vertical lets. A central vertical brace 60 extends vertically between the first and second cross-members 58a,58b, and a skin 62 is mounted to the cross-members 58a, 58b and the vertical brace. As described above, the skin 62 can comprise many different materials that allow water and other liquids to pass but block trash and other debris, with a suitable material being a commercially available screen with 5 mm openings. Other screens having different sized openings can be used, and the skin can have different sized openings at different locations on the insert 50.

Similar to the insert 10 described above, insert 50 further comprises a top opening 64 to allow water to flow through during large storm overflow. The opening 64 has top bars 66 extending between the second cross-member 58b and top the horizontal leg of the frame 52 to form a grating system to capture large and floating trash and debris during large storm overflow.

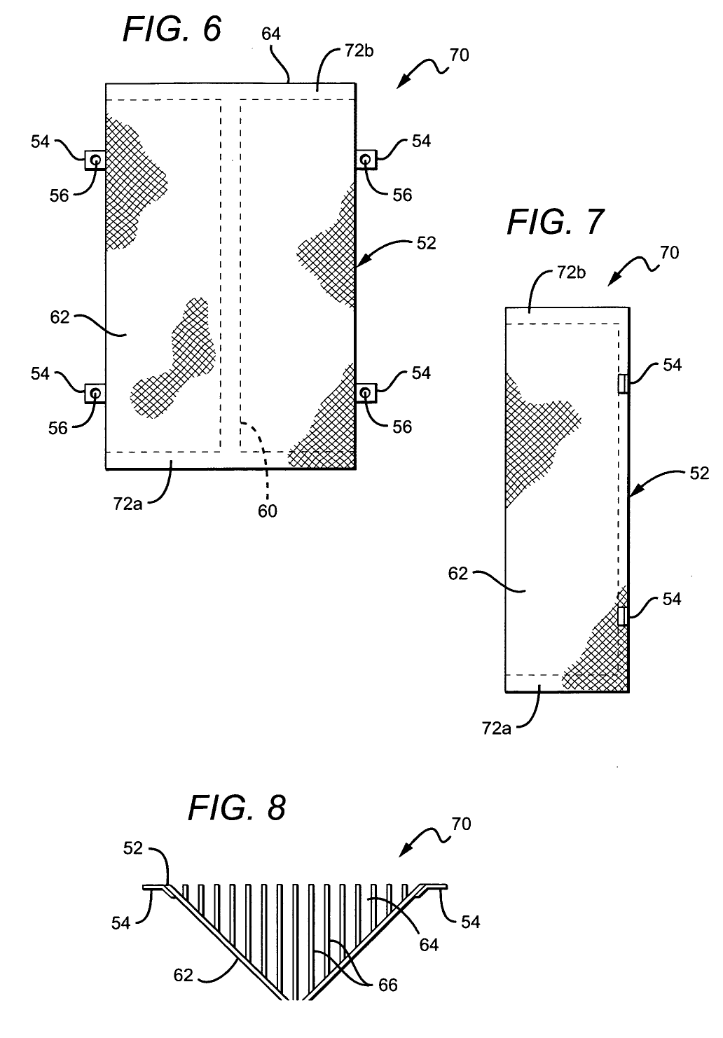

FIGS. 6-8 show another embodiment of a catch basin insert 70 according to the present invention that has many similar features to those in the catch basin insert 50 shown in FIGS. 3-5 and described above. For this embodiment and the embodiments that follow, the same reference numerals will be used for similar features and those similar features will not be described again in detail.

The catch basin insert 70 comprises a mounting frame 52 having mounting tabs 54 with mounting holes 56, a vertical brace 60, a skin 62, a top opening 64 and top bars 66. The catch basin insert also has first and second cross-members 72a and 72b, with the cross members forming an angle between the vertical legs of the frame 52. The cross-members can form many different angles, depending on the particular arrangement of the insert 70, with a suitable angle being approximately 90 degrees. This different shape of the cross-members 72a, 72b results in a different shape for the insert after the skin 62 is attached to the cross-members 72a, 72b and vertical brace 60.

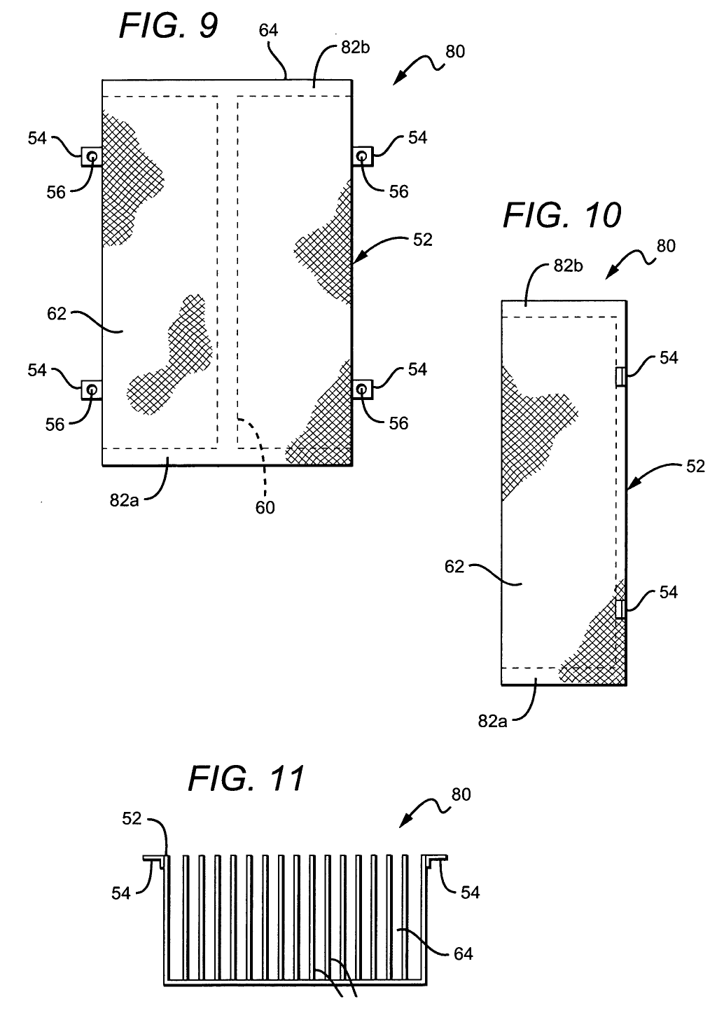

FIGS. 9-11 show still another embodiment of a catch basin insert 80 comprising a mounting frame 52 having mounting tabs 54 with mounting holes 56, a vertical brace 60, a skin 62, a top opening 64 and top bars 66. The catch basin insert also has first and second cross-members 82a and 82b, with the cross members forming a three sided rectangular extension between the vertical legs of the frame 52. The cross-members can form many different sizes, depending on the particular arrangement of the insert 80 and this different shape of the cross-members 82a, 82b results in a different shape for the insert after the skin 62 is attached to the cross-members 82a, 82b and vertical brace 60. It is understood that other cross-members according to the present inventor can also have more than three sides or other shapes beyond those described herein.

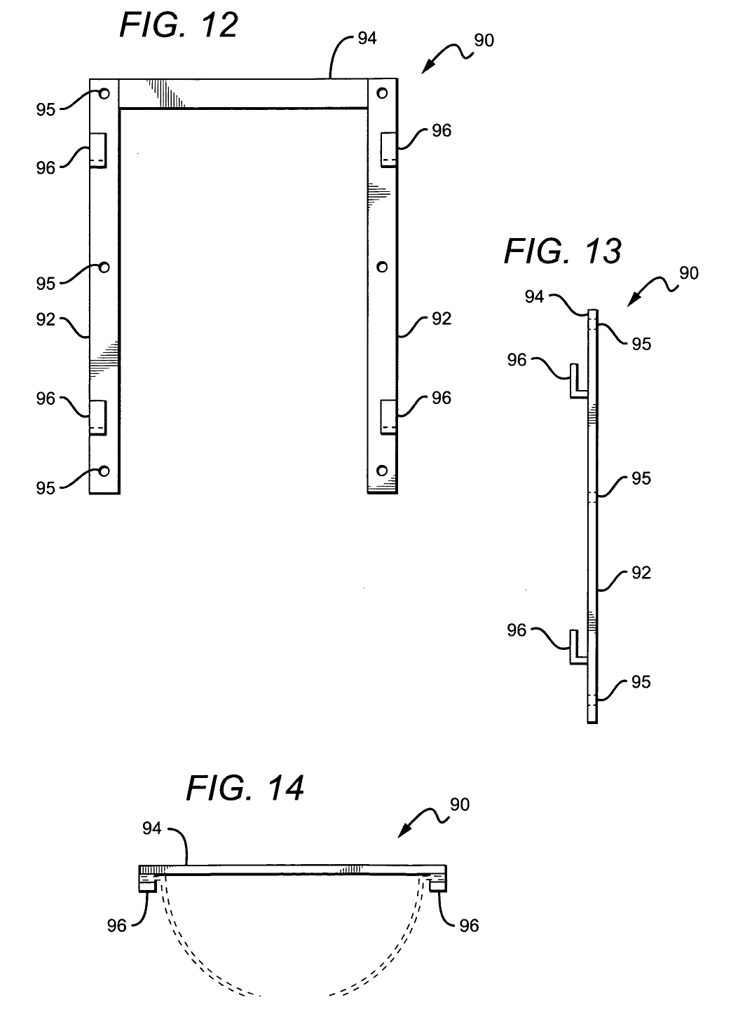

The inserts according to the present invention can also be arranged so that they are easily removed from the catch basin. FIGS. 12-14 show one embodiment of a anchoring frame 90 that can be used in a catch basin insert system that allow for easy removal of part of the system. The frame 90 comprises vertical legs 92 and a top horizontal member 94, with the vertical legs 92 having mounting holes 95. The frame 90 can be anchored to the wall of a catch basin by mounting methods that cooperate with the mounting holes 95, such as by mounting screws. The anchoring frame 90 has four catch fingers 96 each of which opens upward. The fingers 96 are arranged to capture one of the tabs 54 in the catch basin inserts described above. This allows the catch basin inserts to be mounted in place by sliding each one of the tabs 54 in a respective one of the fingers 96, with gravity holding the insert in place. The insert can then be removed from the anchoring frame 90 be lifting it out so that the tabs 54 are removed from the fingers 96. Devices, such as removable clips, can be included to help hold the tabs 54 in the fingers 96.

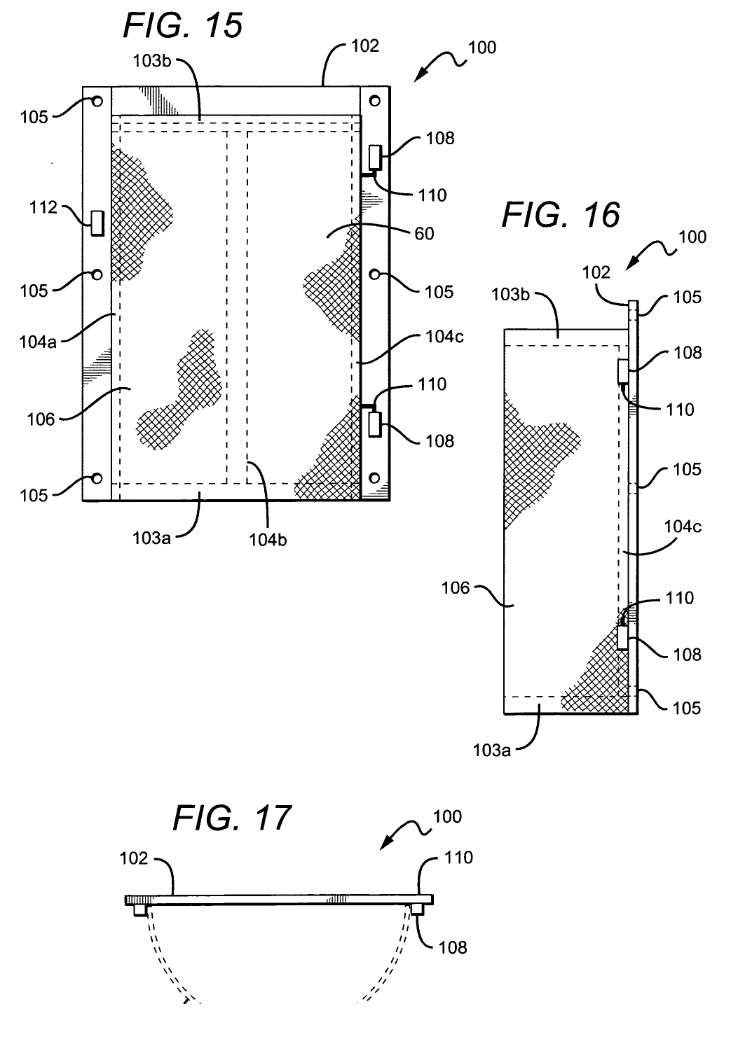

The catch basin insert can also be mounted to an anchoring frame by a hinge arrangement. FIGS. 15-17 another embodiment of a catch basin insert 100 according to the present invention comprising a mounting frame 102 that can be mounted to a catch basin wall at mounting holes 105, as described above. First and second half-circle cross-members 103a, 103b, and first second and third vertical braces 104a, 104b, 104c mounted to and running between the cross-members 103a, 103b. A skin 106 is provided that is similar to the skin described above and is mounted over the cross-members 103a, 103b and vertical braces 104a, 104b, 104c using the methods described above.

One of the frame vertical legs has two hinge receivers 108, each of which is positioned to accept one of two hinge fingers 110 mounted to the third vertical brace 104c. The cooperation of the hinge fingers 110 with the hinge receivers 108 allows for the skin 60, cross-member 103a, 103b and vertical braces 104a, 104b, 104c to hinge open as a unit from the frame 102. The unit can be held in close to the mounting frame 102 by latch 112 that can also be opened to allow the unit to hinge open.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. A catch basin insert, comprising:
a mounting frame;
a skin mounted to said mounting frame, said skin having openings to allow water and other liquids to pass through;
a means for mounting said frame to a wall over an opening; and
a top opening not covered by said skin, said top opening having one or more opening larger than said skin openings to allow a greater volume of water to pass.
